(19) United States
(12) Patent Application Publication
(10) Pub. No.: US 2003/0050892 A1
(43) Pub. Date: Mar. 13, 2003

(54) Electronic point-of-sale check processing method and system

(75) Inventors: Louise C. Clynes, Seattle, WA (US); Michael Bates, Snohomish, WA (US)

Correspondence Address: MICHAEL BEST & FRIEDRICH, LLP, 100 E WISCONSIN AVENUE, MILWAUKEE, WI, 53202, US

(73) Assignee: eFunds Corporation, Milwaukee, WI (US)

(21) Appl. No.: 09/948,861

(22) Filed: Sep. 7, 2001

(51) Int. Cl. G06F 17/60

(52) U.S. Cl. 705/45

(57) ABSTRACT

A method and system of improving the efficiency of electronic point-of-sale check processing. An electronic payment system infrastructure is positioned at a point-of-sale to support a process by which the MICR data from a paper check is converted into a fully electronic ACH transaction and entered into the banking system for a more rapid, and lower cost clearing process.

### BACKGROUND OF THE INVENTION

The present invention relates to systems and methods of rating debit worthiness. More particularly, the invention relates to a system and method for facilitating the acceptance of paper checks at points-of-sale.

Despite predictions that check volume will decline, checks continue to be the dominant form of payment for consumer purchases at points-of-sale. Approximately one quarter of payments at points-of-sale come from checks, and up to eighteen billion checks are written at retail points-of-sale each year. The cost of check processing, return item handling, collection efforts, and fraud losses continue to rise as check volume grows.

Paper checks must be deposited with a bank. The deposit process involves relatively significant human handling. A paper check contains important information such as an address, phone number, account number, and signature. Accordingly, paper check handling provides opportunities for fraud and identity theft. Of course, consumers are required to manually fill in a lot of information on a paper check, and maintain a checkbook for bookkeeping purposes. Many find these tasks annoying.

Another problem with paper checks is that their acceptance is usually limited to a local area where the financial institution that issued the subject check is readily available for check processing. This limits the ability of a retailer to attract and retain check-using consumers outside of the retailer's local region.

Yet another problem with paper checks is that there is always a time lag from the original presentation of a check to the actual receipt of the return check transaction. This limits the ability of a retailer to prevent and collect returned items and control check fraud. A time lag of seven to fourteen days is typical.

### SUMMARY OF THE INVENTION

Accordingly, there is a need for an improved method and system of handling and processing paper checks. Further, it would be beneficial to reduce a turn around time, have a more reliable check fraud prevention scheme, and reduce the handling of paper checks. The inventors have determined that the electronic payment system infrastructure in place at the point-of-sale today readily supports a process by which magnetic ink character recognition (“MICR”) data from the check can be converted into a fully electronic Automated Clearing House (“ACH”) transaction and entered into the banking system for a more rapid, lower cost clearing process. The result is reduced operating costs and check losses to retailers and financial institutions, and faster cash flow to the retailer.

Consequently, the invention provides a method of conducting check payment transaction processing. In one embodiment, the method includes receiving a paper check issued by a payor (or a consumer) financial institution, capturing transaction data from the paper check, capturing transaction data (including data from a paper check) at a point-of-sale, retrieving a payor personal data file, and processing the transaction data. The method also includes generating an authorization receipt, and obtaining a payor approval. The method also includes initiating an electronic check ACH transaction processing entry.

The method may also involve receiving the transaction data from the point-of-sale, matching the transaction data with a plurality of databases, validating the transaction data, determining a payor classification, and transmitting the payor classification to the point-of sale. The invention provides a scheme for determining the payor classification and generating a transaction approval or a transaction declination. The electronic check ACH entry is forwarded to the payor financial institution, and a payee (a retailer or merchant) financial institution. A withdrawal is posted to an account at the payor financial institution and a deposit is posted to an account at the payee financial institution. The payor approval and the voided paper check are returned to the consumer.

Despite efforts to pre-authorize paper checks presented at point-of-sale, some items will still be returned by the payor financial institution for insufficient funds or other reasons. Accordingly, the invention also provides a method that manages a returned electronic check ACH transaction processing entry. The method includes re-initiating the returned electronic check ACH transaction processing entry, determining a clearance likelihood of the returned electronic check ACH transaction processing entry, and contributing the returned electronic check ACH transaction processing entry to a shared check authorization network (“SCAN”) database.

The invention also provides a paper check payment transaction processing system. The paper check payment transaction processing system includes at least one paper check transaction data terminal configured to be located at the point-of-sale. Each paper check transaction data terminal is operable to capture transaction data, including data from a paper check, generate an authorization receipt, and display a payor classification and a payor personal data file, among other things. The paper check transaction data terminal is also operable to transmit the transaction data and receive the payor classification and the payor personal data file. The system further includes a financial information management processor coupled to the paper check transaction data terminal. The financial information management processor is operable to receive the transaction data, retrieve and store payor transaction data, retrieve and store a payor personal data file, determine a payor classification, generate an electronic check ACH transaction processing entry, and transmit the payor classification and the payor personal data file.

The financial information management processor is operable to forward the electronic check ACH transaction processing entry to a payor financial institution, forward the electronic check ACH transaction processing entry to a payee financial institution, post a withdrawal to an account at the payor financial institution, and post a deposit to an account at the payee financial institution. The system may optionally include a returned electronic check ACH transaction processing entry management system. The returned electronic check ACH transaction processing entry management system has an initiator operable to re-initiate a returned electronic check ACH transaction processing entry, an analyzer operable to determine a clearance likelihood of the returned electronic check ACH transaction processing entry, and a contributor operable to contribute the returned electronic check ACH transaction processing entry to a SCAN database.

An example of how the system operates is as follows. A retailer receives a blank paper check without a signature from a consumer. The retailer runs the paper check through a paper check transaction data terminal to capture the transaction data, including data on the paper check such as MICR data. The retailer enters an amount of a purchase, among other things, into the paper check transaction data reader. The captured and entered information is transmitted to a financial information processor for an approval. Upon approval, an authorization receipt is generated. Once the consumer signs the authorization receipt, the financial information processor generates an electronic check ACH transaction processing entry. The authorization receipt may include an electronic re-initiation of the electronic check ACH entry in the event that the transaction is returned unpaid. The authorization receipt may include an indication of a return check service fee with a dollar amount to be collected electronically.

The retailer then provides the consumer with a copy of the authorization receipt, voids the paper check and hands the voided paper check to the consumer for safekeeping. The financial information processor then transmits the electronic check ACH transaction processing entry as a withdrawal to the payor financial institution, and a withdrawal is posted in an account of the consumer financial institution. The financial information processor also transmits the electronic check ACH entry as a deposit to a retailer financial institution, and a deposit will be posted in an account of the retailer financial institution.

Other features and advantages of the invention will become apparent to those skilled in the art upon review of the following detailed description, claims, and drawings.

### BRIEF DESCRIPTION OF THE DRAWINGS

In the drawings:

FIG. 1 schematically illustrates an electronic check payment process of the invention;

FIG. 2 is a flow chart of an electronic check payment process;

FIG. 2A illustrates an exemplary consumer personal data file;

FIG. 2B illustrates an exemplary authorization database;

FIG. 3 illustrates an exemplary paper check;

FIG. 4 illustrates an exemplary authorization receipt;

FIG. 5 is a perspective view of an exemplary paper check transaction data terminal;

FIG. 6 illustrates a typical key sequence and a corresponding display message sequence;

FIG. 7A is a block diagram view of a returned electronic check ACH transaction presentment system; and

FIG. 7B is a flow chart of a returned electronic check ACH transaction presentment process.

### DETAILED DESCRIPTION

Before embodiments of the invention are explained, it is to be understood that the invention is not limited in its application to the details of the construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

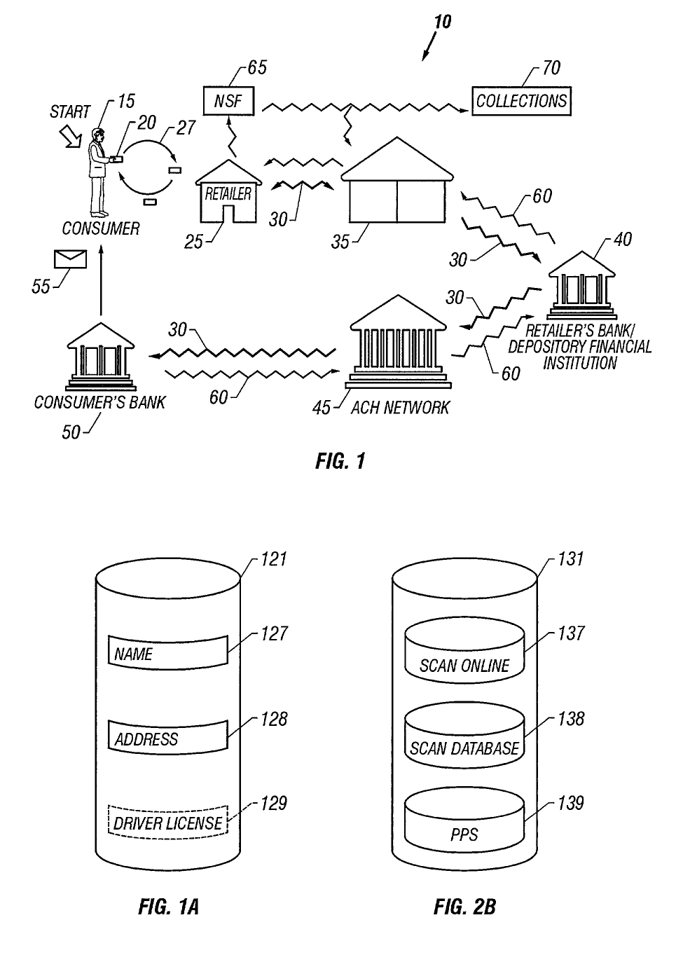

FIG. 1 illustrates an electronic check payment processing system 10. The system 10 is designed to accept checks from consumers, such as a consumer 15. The consumer hands a blank paper check 20 to a retailer 25 at a point-of-sale 27. The retailer 25 sends transaction data, including data from the paper check (not shown), through a process link 30 to a financial information management processor 35. After the financial information management processor 35 has received, processed, and validated the blank paper check data, the financial information management processor 35 transmits a consumer classification (not shown) through the process link 30 back to the retailer 25. If the consumer classification is acceptable, the retailer 25 then voids and returns the blank paper check 20 to the consumer 15.

Assuming the consumer classification is acceptable, an authorization receipt (discussed below) is generated by the retailer 25 for the consumer 15 to sign. Once the consumer 15 signs the authorization receipt, the retailer 25 signals through the process link 30 to the financial information management processor 35 to initiate an electronic check ACH entry (not shown) through the process link 30 to a retailer bank/depository financial institution 40. The retailer bank/depository financial institution 40 forwards the electronic check ACH entry through the process link 30 via an ACH network 45 as an electronic withdrawal (not shown) to a consumer bank 50. The consumer bank 50 then posts a withdrawal to a consumer account (not shown). When the withdrawal is cleared, the retailer bank/depository financial institution 40 then posts a deposit to a retailer account (not shown). All the cleared items are detailed and sent to the consumer 15 in a bank statement 55.

If the withdrawal is not cleared, due to non-sufficient funds for example, the consumer bank 50 signals the financial information management processor 35 and the retailer 25 of the rejection and returns the transaction through a representment link 60. The rejection and return travel through the ACH network 45 and the retailer bank/depository financial institution 40. In one embodiment, the retailer 25 may re-initiate the electronic check payment process up to two times. If the attempts to re-initiate the electronic check payment process fail, the withdrawal item will be returned to the retailer 15 as an outstanding non-sufficient funds (“NSF”) item 65. The outstanding NSF item 65 is forwarded to a collection agency 70 and to the financial information management processor 35 to be recorded as a bad check. In addition, an update or modification is made to a consumer personal data file (discussed later) to indicate that the person who presented the check is a bad check writer. The updated file is also sent to the financial information management processor 35 and stored in the SCAN database. In other words, the consumer personal data file is contributed to the SCAN database.

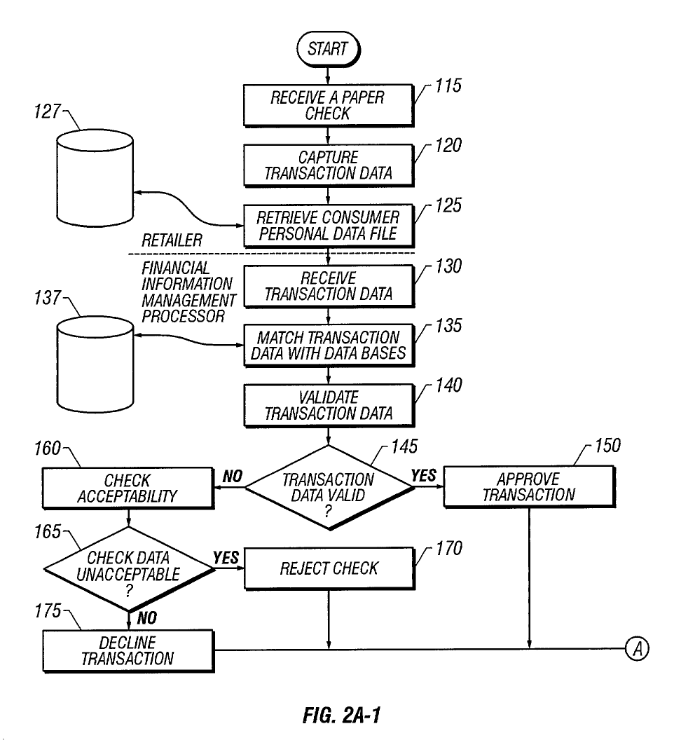

FIG. 2 is a detailed view of an electronic check payment process 100, according to the invention. The process 100 begins at a receiving step 115. A retailer (not shown) receives a paper check (not shown) from a consumer or a payor (not shown). Transaction data, including data from the paper check, is captured by a paper check transaction data terminal (which is discussed later) at a capturing step 120. Thereafter, a consumer personal data file 121 is retrieved at a retrieving step 125. An exemplary personal data file 121 is shown in FIG. 2A. Retrieving the consumer personal data file 121 at the retrieving step 125 includes searching a payor name 127 and a payor address 128, matching a shared driver's license database 129, and displaying, when matched, a payor driver's license number.

Thereafter, processing in a financial information management processor (not shown) starts as follows. The transaction data is received at a second receiving step 130, and matched against an authorization database 131 in a matching step 135. An exemplary authorization database 131 is shown in FIG. 2B. The authorization database 131 includes a plurality of databases including a SCAN online database 137, a SCAN database 138, a primary payment system (“PPS”) 139. The transaction data is validated in a validating step 140. Based on the transaction data received, a consumer classification is determined in a first decision step 145. If the transaction data is valid, the transaction is approved and an “approval” consumer classification is generated in an approval step 150.

If the transaction data is invalid, the transaction data, including the paper check data, is further examined in a checking step 160. If the paper check data, which is examined in a second decision step 165, is unacceptable, the paper check is rejected in a rejection step 170. Otherwise, the transaction is simply classified as declined in a declination step 175. A consumer classification is then displayed in a displaying step 180 at the paper check transaction data terminal of the retailer. However, it should be apparent to those of ordinary skill in the art that there may be more or less classifications than those shown in FIG. 2.

Assuming the consumer classification is an approval, an authorization receipt is generated in a generating step 185. The retailer then obtains a signed authorization receipt (step 190) to initiate an electronic ACH entry in an initiating step 193. The electronic ACH entry is forwarded to a consumer financial institution in a first forwarding step 195, and a withdrawal is posted at a consumer account in a posting step 200. It is then determined if the withdrawal is clear at step 205. If the withdrawal item is not cleared, the process 100 enters a second initiating step 210, in which a returned electronic ACH entry is initiated. (The returned electronic ACH entry will be discussed later.) Otherwise, an electronic check entry is forwarded to a retailer financial institution in a second forwarding step 215, and a deposit is posted at a retailer account in a second posting step 220. Of course, the forwarding and the posting processes at different financial institutions may be arranged differently.

To finish the process, the retailer initiates a terminating process as follows. The retailer voids the paper check in a marking step 225 and returns the paper check back to the consumer in a returning step 230. The retailer also generates a second copy of the authorization receipt in a second generating step 230. The retailer then finishes the transaction by handing the second copy of the authorization receipt to the consumer in a second returning step 240.

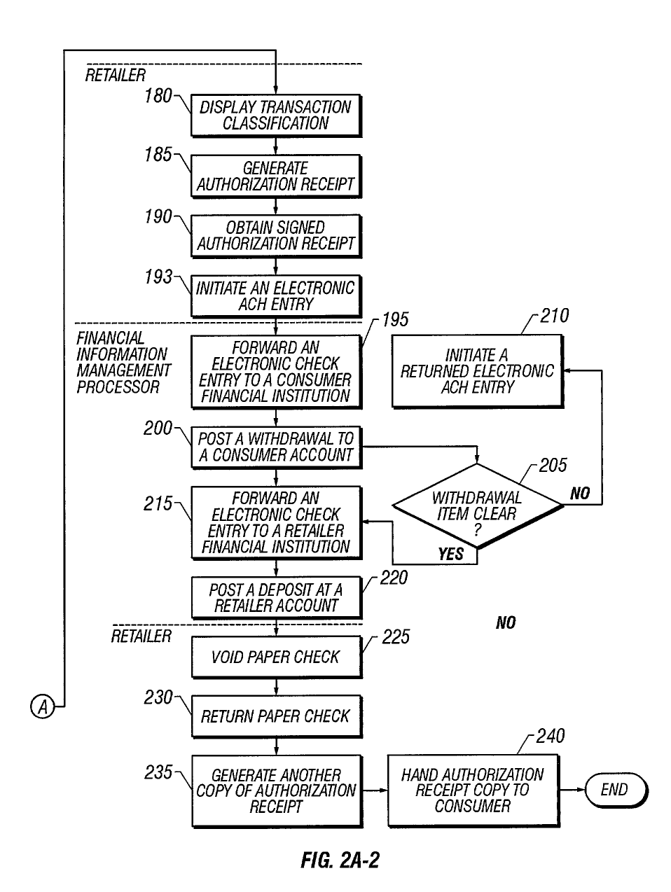

FIG. 3 shows a blank paper check 300. The blank paper check 300 shows a magnetic ink character recognition (“MICR”) data line 310. The MICR data line 310 includes a bank routing number 315, a bank account number 320, and a paper check number 325. Separating these numbers is a series of special MICR symbols including a transit routing symbol 330 and an “on-us” symbol 335.

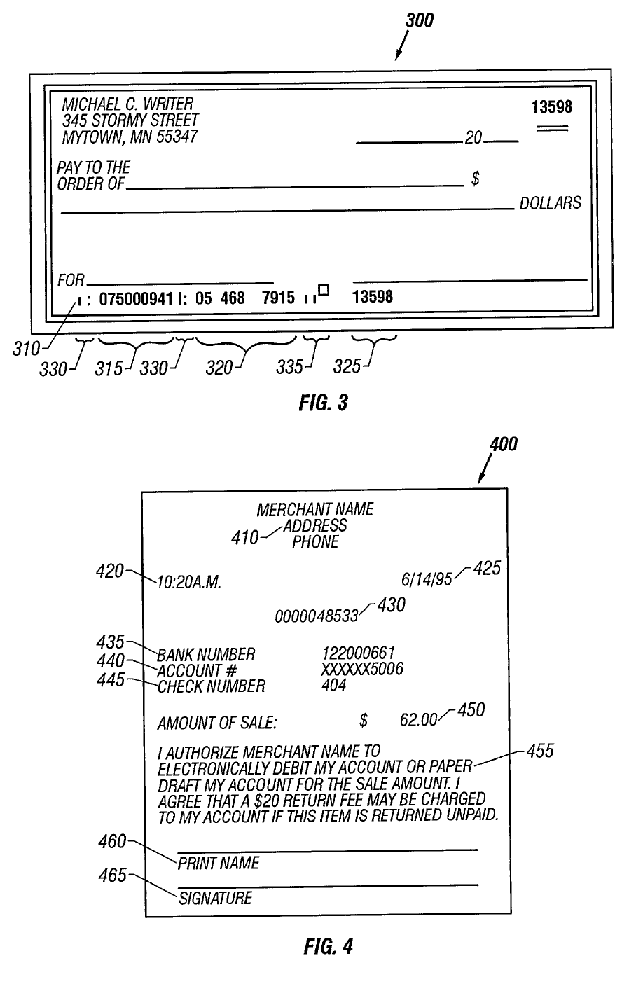

An embodiment of an authorization receipt 400 is shown in FIG. 4. Upon receiving a consumer approval classification, an authorization receipt 400 is generated at a point-of-sale. The authorization receipt 400 includes a retailer identification 410, with a retailer or a merchant name, a retailer address, and a retailer phone number. The authorization receipt 400 also includes a transaction time 420, a transaction date 425, a transaction item number 430, a bank routing number 435, an account number 440, a check number 445, a transaction amount 450, a consumer authorization for debit claim 455, a consumer name 460 in printed form, and a signature line 465 for a signature. As noted above, after the consumer signs the authorization receipt 400, the financial information processor 35 generates an electronic check ACH transaction processing entry (not shown). The retailer then returns a copy of the authorization receipt 400 to the consumer for safekeeping while the retailer keeps the signed authorization receipt for verification purposes. The authorization receipt 400 provides an authentication mechanism that can be manually signed and the signed authorization receipt carries with it all of the attributes of authenticity, data integrity, and non-repudiation that a signed paper check carries. It should be apparent to those of ordinary skill in the art that the authorization receipt 400 may include a similar but different set of information than what is shown in FIG. 4.

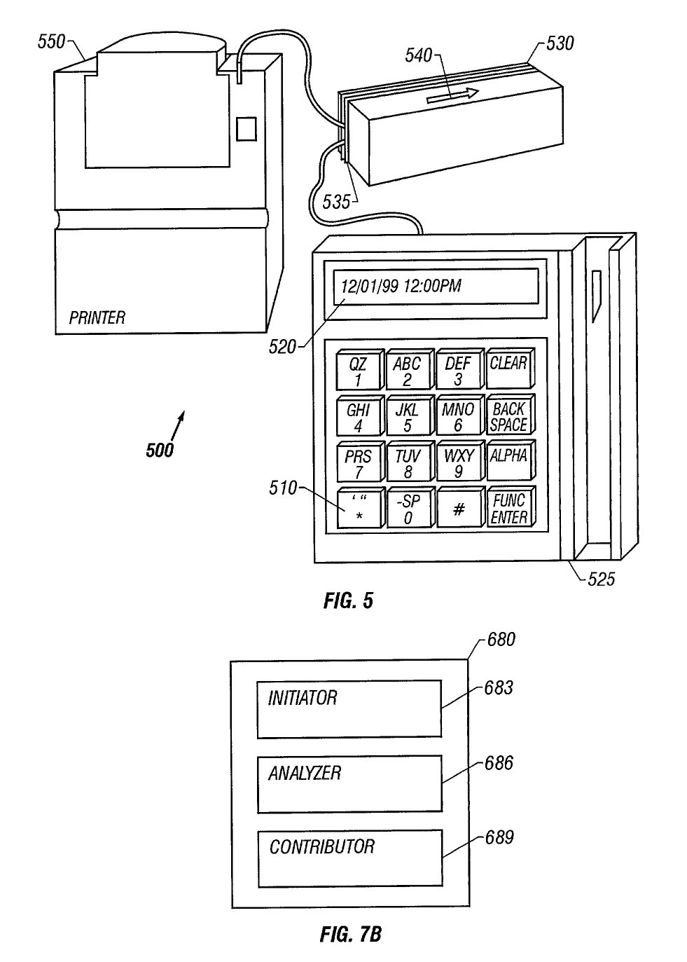

Referring to FIG. 5, an exemplary paper check transaction data terminal 500 is shown. The data terminal 500 includes a keypad 510, a display 520, and a communication device (not shown) housed in an interactive unit 525. The retailer (not shown) uses the keypad 510 of the interactive unit 525 to key in, among other things, a transaction amount. The interactive unit 525 displays the transaction amount on the display 520. The paper check transaction data terminal 500 also includes a paper check recognition unit 530. The recognition unit 530 is used to read or scan in information from a paper check such as the one shown in FIG. 3. In operation, the retailer inserts a consumer paper check into the paper check recognition unit 530 in a slot 535 in a direction 540. The paper check transaction data terminal 500 further includes a printer unit 550 which is used to print an authorization receipt (such as the authorization receipt 400), among other things. Of course, the paper check transaction data terminal 500 may include other devices such as a modem, or be housed a single unit.

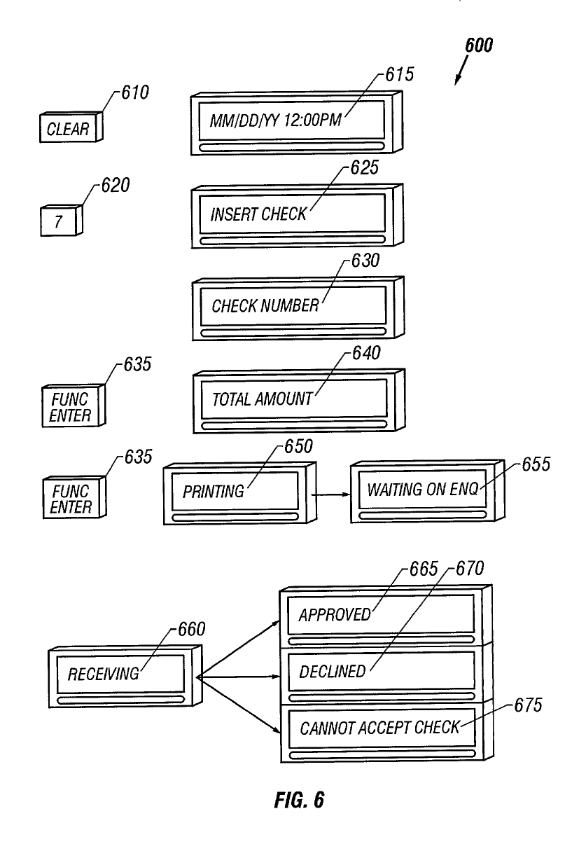

FIG. 6 shows a typical key sequence and a corresponding display message sequence 600 the retailer (not shown) may use and read from the paper check transaction data terminal 500. A retailer first presses a clear key 610 on the keypad 510 of the interactive unit 525 shown in FIG. 5. A date/time message 615 is displayed on the display 520. The retailer then presses a “7” key 620 to initiate a check insert, for example. The display then shows a prompt message 625 for inserting a paper check. After the paper check has been inserted in the paper check recognition unit 530, the display shows a second prompt message 630 for a check number entry. The retailer then keys in the check number and presses an enter key 635 to signal completion of the check number entry. The display 520 then shows a third prompt message 640 for a purchase amount entry, the retailer enters the purchase amount and finishes the purchase amount entry by pressing the enter key 635.

A first action message 650 is displayed to show that an authorization receipt is being generated by the printer unit 550. A second action message 655 showing “WAITING ON ENQ” is displayed to show a transmission is taking place and the paper check transaction data terminal 500 is waiting for a response. As the paper check transaction data terminal 500 is receiving the response, a third action message 660 is displayed. Afterward, depending on the response, one of three response messages is displayed, including an approval message 665 for an approved transaction, a declination message 670 for a declined transaction, and an unacceptable message 675 for an unacceptable check. It should be readily understood by those of ordinary skill in the art that the key sequence may include other combinations, and that the display messages may also be different than those shown in FIG. 6.

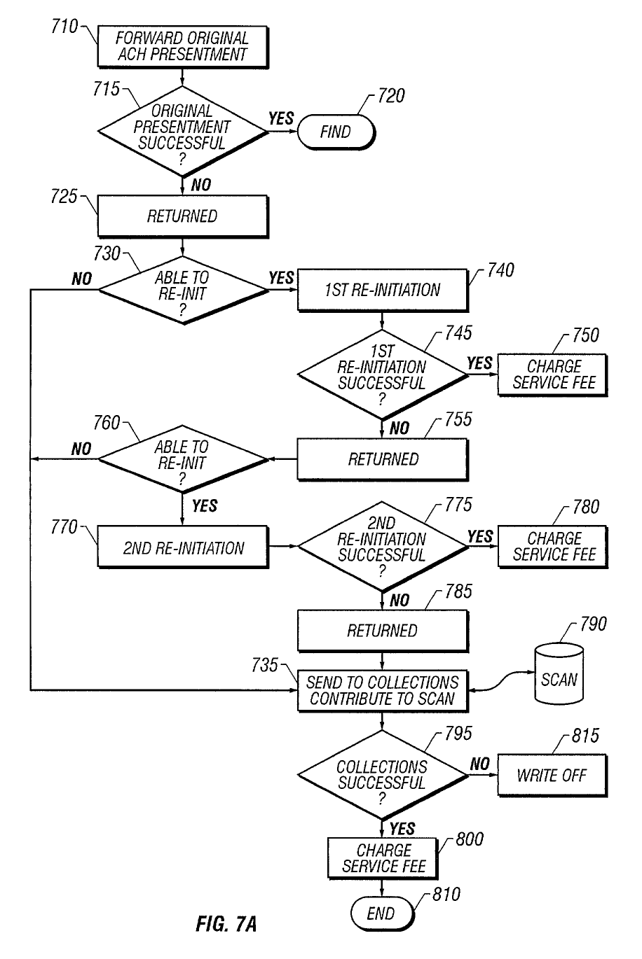

FIG. 7A is a block diagram view of a returned electronic check ACH transaction presentment system 680. The returned electronic check ACH transaction presentment system 680 includes an initiator 683 operable to re-initiate a returned electronic check ACH entry, an analyzer 686 operable to determine a clearance likelihood of the returned electronic check ACH entry and a contributor 689 operable to contribute the returned electronic check ACH entry to a SCAN database (discussed later). Of course, the presentment system 680 may include more components than what is shown in FIG. 7A.

A detailed view of an electronic check ACH transaction presentment process 700 is shown in FIG. 7B. The process 700 starts with a forwarding step 710, the financial information processor 35 initiates an original ACH entry or presentment. The presentment is checked at 715. If the original ACH presentment is successful, the process 700 ends, as shown at an end step 720. Otherwise, the process 700 enters a returning step 725 indicating that the original ACH presentment failed. Next, an attempt to re-initiate the presentment by determining a clearance likelihood of the returned electronic check ACH entry is made using an analyzer at step 730. If the original ACH presentment cannot be re-initiated, a collection process is initiated as shown at a collecting step 735. Otherwise, the process 700 continues with a first re-initiating step 740, an initiator of the first re-initiating step 740 then re-initiates the returned electronic check ACH entry.

If the first re-initiation is successful, a charging step 750 is executed, a service fee is charged, and the process 700 comes to an end. Otherwise, the process 700 enters a second returning step 755 indicating that the first re-initiation failed (is returned). Another attempt to re-initiate the presentment by determining a clearance likelihood of the returned electronic check ACH entry is made using an analyzer at step 760. If the first re-initiation cannot be re-initiated, the collecting step 735 is executed. Otherwise, the process 700 enters a second re-initiating step 770, and an initiator of the second re-initiating step 770 then re-initiates the returned electronic check ACH entry. If the second re-initiation is successful (as determined at step 775), the process 700 comes to a second charging step 780 indicating the second re-initiation is successful, a second service fee is charged and the process 700 comes to an end. Otherwise, the process 700 enters a third returning step 785 indicating that the second re-initiation failed.

Once the re-initiation process stops, the collection process starts as shown at the collecting step 735 while a contributor of the collecting step 735 also contributes the returned electronic check ACH entry to a SCAN database 790. If the collection process is successful (step 795), a service fee is charged in a charging step 800 and the process 700 comes to an end at step 810. Otherwise, a write off step 815 is initiated, indicating that the collection process is unsuccessful, the withdrawal item is written off.

It should be readily understood by those of ordinary skill in the art that when the withdrawal item becomes uncollectible and turned over to collections, the item may be skip traced through a debit bureau. If the skip trace is successful, the retailer may be charged for the recovery of the withdrawal item. If the skip trace is unsuccessful, the financial information management processor may be charged for the recovery of the item. In either case, the uncollectible item is automatically contributed to the SCAN database 790 as negative information on the check writer.

As can be seen from the above, the invention provides a method and system of conducting a check payment transaction processing. Various features and advantages of the invention are set forth in the following claims.

What is claimed is:

1. A method of conducting a check payment transaction, the method comprising:
receiving a paper check issued by a payor financial institution at a point-of-sale;
capturing transaction data, including data from the paper check, at the point-of-sale;
processing the transaction data;
generating an authorization receipt;
obtaining a payor approval;
initiating an electronic check ACH entry; and
initiating a terminating process.

2. A method as in claim 1, wherein capturing transaction data comprises reading a MICR data of the paper check.

3. A method as in claim 1, wherein processing the transaction data comprises:
receiving the transaction data from the point-of-sale;
matching the transaction data with a plurality of databases;
validating the transaction data;
determining a payor classification; and
transmitting the payor classification to the point-of sale.

4. A method as in claim 3, wherein determining the payor classification further comprises generating a transaction approval.

5. A method as in claim 3, wherein determining the payor classification further comprises generating a transaction declination.

6. A method as in claim 1, further comprising managing a returned electronic check ACH entry.

7. A method as in claim 6, further comprising:
re-initiating of the returned electronic check ACH entry;
determining a clearance likelihood of the returned electronic check ACH entry; and
contributing the returned electronic check ACH entry to a SCAN database.

8. A method as in claim 1, wherein initiating an electronic check ACH entry further comprises:
forwarding the electronic check ACH entry to the payor financial institution;
forwarding the electronic check ACH entry to a payee financial institution;
posting a withdrawal to an account at the payor financial institution; and
posting a deposit to an account at the payee financial institution.

9. A method as in claim 1, wherein initiating a terminating process comprises:
marking the paper check void;
returning the payor approval; and
returning the voided paper check.

10. A method of conducting a check payment transaction, the method comprising:
capturing transaction data, including data from a paper check, at the point-of-sale;
processing the transaction data;
generating an authorization receipt;
obtaining a payor approval; and
initiating an electronic check ACH entry.

11. A method as in claim 10, wherein capturing transaction data comprises reading a MICR data of the paper check.

12. A method as in claim 10, wherein processing the transaction data comprises:
receiving the transaction data from the point-of-sale;
matching the transaction data with a plurality of databases;
validating the transaction data;
determining a payor classification; and
transmitting the payor classification to the point-of sale.

13. A method as in claim 12, wherein determining the payor classification further comprises generating a transaction approval.

14. A method as in claim 12, wherein determining the payor classification further comprises generating a transaction declination.

15. A method as in claim 10, further comprising managing a returned electronic check ACH entry.

16. A method as in claim 15, further comprising:
re-initiating of the returned electronic check ACH entry;
determining a clearance likelihood of the returned electronic check ACH entry; and
contributing the returned electronic check ACH entry to a SCAN database.

17. A method as in claim 10, wherein initiating an electronic check ACH entry further comprises:
forwarding the electronic check ACH entry to the payor financial institution;
forwarding the electronic check ACH entry to a payee financial institution;
posting a withdrawal to an account at the payor financial institution; and
posting a deposit to an account at the payee financial institution.

18. A paper check payment system for a point-of-sale, the system comprising:
a paper check transaction data terminal configured to be located at the point-of-sale, the paper check transaction data terminal operable to capture transaction data, including data from a paper check, generate an authorization receipt, and display a payor classification, and the paper check transaction data terminal also operable to transmit the transaction data and to receive the payor classification; and
a financial information management processor coupled to the paper check transaction data terminal, the financial information management processor operable to receive the transaction data, retrieve and store payor transaction data, determine a payor classification, generate an electronic check ACH entry, and transmit the payor classification.

19. A system as in claim 18, wherein the paper check transaction data terminal includes a MICR reader terminal.

20. A system as in claim 18, wherein the financial information management processor is operable to forward the electronic check ACH entry to a payor financial institution, forward the electronic check ACH entry to a payee financial institution, post a withdrawal to an account at the payor financial institution; and post a deposit to an account at the payee financial institution.

21. A system as in claim 18, wherein the financial information management processor is operable to generate a transaction approval.

22. A system as in claim 18, wherein the financial information management processor is operable to generate a transaction declination.

23. A system as in claim 18, further includes a returned electronic check ACH entry management system comprising:
an initiator operable to re-initiate a returned electronic check ACH entry;
an analyzer operable to determine a clearance likelihood of the returned electronic check ACH entry; and
a contributor operable to contribute the returned electronic check ACH entry to a SCAN database.

24. A method of conducting a check payment transaction processing, the method comprising:
receiving a paper check issued by a payor financial institution at a point-of-sale;
capturing transaction data, including data from the paper check, at the point-of-sale;
retrieving a payor personal data file;
processing the transaction data;
generating an authorization receipt;
obtaining a payor approval;
initiating an electronic check ACH transaction processing entry; and
initiating a terminating process.

25. A method as in claim 24, wherein capturing transaction data comprises reading MICR data of the paper check.

26. A method as in claim 24, wherein processing the transaction data comprises:
receiving the transaction data from the point-of-sale;
matching the transaction data with a plurality of databases;
validating the transaction data;
determining a payor classification; and
transmitting the payor classification to the point-of sale.

27. A method as in claim 24, wherein determining the payor classification further comprises generating a transaction approval.

28. A method as in claim 24, wherein determining the payor classification further comprises generating a transaction declination.

29. A method as in claim 24, further comprising managing a returned electronic check ACH transaction processing entry.

30. A method as in claim 29, further comprising:
re-initiating of the returned electronic check ACH transaction processing entry;
determining a clearance likelihood of the returned electronic check ACH transaction processing entry; and
contributing the returned electronic check ACH transaction processing entry to a SCAN database.

31. A method as in claim 24, wherein initiating an electronic check ACH transaction processing entry further comprises:
forwarding the electronic check ACH transaction processing entry to the payor financial institution;
forwarding the electronic check ACH transaction processing entry to a payee financial institution;
posting a withdrawal to an account at the payor financial institution; and
posting a deposit to an account at the payee financial institution.

32. A method as in claim 24, wherein initiating a terminating process comprises:
marking the paper check void;
returning the payor approval; and
returning the voided paper check.

33. A method as in claim 24, wherein retrieving a payor personal data file includes:
searching a payor name and a payor address;
matching a shared driver's license database; and
displaying, when matched, a payor driver's license number.

34. A method of conducting a check payment transaction processing, the method comprising:
capturing transaction data, including data from a paper check, at the point-of-sale;
retrieving a payor personal data file;
processing the transaction data;
generating an authorization receipt;
obtaining a payor approval; and
initiating an electronic check ACH transaction processing entry.

35. A method as in claim 34, wherein capturing transaction data comprises reading a MICR data of the paper check.

36. A method as in claim 34, wherein processing the transaction data comprises:
receiving the transaction data from the point-of-sale;
matching the transaction data with a plurality of databases;
validating the transaction data;
determining a payor classification; and
transmitting the payor classification to the point-of sale.

37. A method as in claim 36, wherein determining the payor classification further comprises generating a transaction approval.

38. A method as in claim 36, wherein determining the payor classification further comprises generating a transaction declination.

39. A method as in claim 34, further comprising managing a returned electronic check ACH transaction processing entry.

40. A method as in claim 39, further comprising:
re-initiating of the returned electronic check ACH transaction processing entry;
determining a clearance likelihood of the returned electronic check ACH transaction processing entry; and
contributing the returned electronic check ACH transaction processing entry to a SCAN database.

41. A method as in claim 34, wherein initiating an electronic check ACH transaction processing entry further comprises:
forwarding the electronic check ACH entry to the payor financial institution;
forwarding the electronic check ACH entry to a payee financial institution;
posting a withdrawal to an account at the payor financial institution; and
posting a deposit to an account at the payee financial institution.

42. A method as in claim 34, wherein retrieving a payor personal data file includes:
searching a payor name and a payor address;
matching a shared driver's license database; and
displaying, when matched, a payor driver's license number.

43. A paper check payment transaction processing system for a point-of-sale, the system comprising:
a paper check transaction data terminal configured to be located at the point-of-sale, the paper check transaction data terminal operable to capture transaction data, including data from a paper check, generate an authorization receipt, display a payor classification, and display a payor personal data file, and the paper check transaction data terminal also operable to transmit the transaction data and to receive the payor classification; and
a financial information management processor coupled to the paper check transaction data terminal, the financial information management processor operable to receive the transaction data, retrieve and store payor transaction data, retrieve and store payor personal data file, determine a payor classification, generate an electronic check ACH transaction processing entry, and transmit the payor classification and the payor personal data file.

44. A system as in claim 43, wherein the paper check transaction data terminal includes a MICR reader terminal.

45. A system as in claim 43, wherein the financial information management processor is operable to forward the electronic check ACH transaction processing entry to a payor financial institution, forward the electronic check ACH transaction processing entry to a payee financial institution, post a withdrawal to an account at the payor financial institution; and post a deposit to an account at the payee financial institution.

46. A system as in claim 43, wherein the financial information management processor is operable to generate a transaction approval.

47. A system as in claim 43, wherein the financial information management processor is operable to generate a transaction declination.

48. A system as in claim 43, further includes a returned electronic check ACH transaction processing entry management system comprising:
an initiator operable to re-initiate a returned electronic check ACH transaction processing entry;
an analyzer operable to determine a clearance likelihood of the returned electronic check ACH transaction processing entry; and
a contributor operable to contribute the returned electronic check ACH transaction processing entry to a SCAN database.
